(19) United States
(12) Patent Application Publication
(10) Pub. No.: US 2004/0225408 A1
(43) Pub. Date: Nov. 11, 2004

(54) Substrate end effector

(76) Inventor: Preston Whitcomb, Hull, MA (US)

Correspondence Address: FISH & RICHARDSON PC, 225 FRANKLIN ST, BOSTON, MA, 02110, US

(21) Appl. No.: 10/664,694

(22) Filed: Sep. 16, 2003

Related U.S. Application Data
(60) Provisional application No. 60/411,372, filed on Sep. 16, 2002.

(51) Int. Cl. G06F 7/00

(52) U.S. Cl. 700/213

(57) ABSTRACT

A system for handling substrates held in a carrier, the system comprising a robot having an articulating robotic arm, a processor for controlling the robotic arm, an end effector attached to a moveable end of the robotic arm, the end effector comprising a blade having a first end and a second end, the blade having an active area for sensing a distance between the end and the substrate, and a passive gripper attached to the first end of the blade and an active gripper attached to the second end of the blade.

### CROSS-REFERENCE TO RELATED APPLICATIONS

This application claims priority to U.S. Provisional Application Ser. No. 60/411,372, filed on Sep. 16, 2002, the entire contents of which is incorporated herein by reference.

### TECHNICAL FIELD

This invention relates to a substrate handling robot, and more specifically to a robotic arm end effector.

### BACKGROUND

Processing of a single semiconductor wafer often takes place in multiple fabrication facilities. Systems have been developed that are capable of sorting, tracking and packing/unpacking substrates to and from shipping containers. Such systems require transporting substrates such as semiconductor wafers into and out of the shipping containers. Systems for packing and unpacking substrate material often utilize vacuum wands and commercially available robotic systems. Such robotic systems can include one robotic arm assembly carrying multiple end effectors of different designs tailored to the needs of the specific substrate.

There is a trend toward semiconductor wafer substrates becoming thinner due to packaging demands, improved thermal management, and a host of other reasons. Thinner substrates and the corresponding dimensional aspects of substrate cassette carriers impact the handling requirements of robotic arms and robotic end effectors. For example, wafer substrates are more likely to bow and warp when reduced in thickness. Wafer substrates including flats or fiducials add uncertainty to the location of the substrate within the cassette carriers. The overall physical characteristics of some silicon substrate wafers and the associated cassette holders can make precise determinations of position and orientation of the substrate difficult. Such substrate characteristics result in clearance issues when placed within substrate carriers which are difficult to overcome with available robotic end effector technology. Minimizing the end effector contact with the substrates reduces the possibility of contamination or damage. The total number of steps during substrate processing as well as the speed with which the robotic arm moves can limit the overall system throughput.

### SUMMARY

In one aspect, the invention features a system for handling substrates held in a carrier and having a robot including an articulating robotic arm, a processor for controlling the robotic arm, an end effector attached to a moveable end of the robotic arm, the end effector including a blade having a first end and a second end, the blade having an active area for sensing a distance between the end and the substrate, and a passive gripper attached to the first end of the blade and an active gripper attached to the second end of the blade. The substrate handled by the system can include, for example, a silicon wafer.

In one embodiment, the end effector further includes a mapping sensor for detecting the mean vertical location of a substrate contained within the carrier. In another embodiment, the blade of the end effector is formed from a silicon wafer. In another embodiment, the blade is turned from a ceramic substrate. In various embodiments, the blade has a thickness less than about 1000 microns and preferably, less than about 750 microns. In one embodiment, the active area is formed on the blade from a metalization or thick layer process. In one embodiment, the active area is adapted to provide at least one of the mean vertical location, the thickness variation, the bow and warp, tilt, and deviation of the substrate within the substrate carrier. In one embodiment, the active area is a measurement transducer. In another embodiment, the active area is a capacitance probe. In various embodiments the active area includes at least one of optical sensor, pneumatic sensor, inductive sensor, ultrasonic sensor. In one embodiment, the active area includes at least three discrete sensors for providing planar information of the substrate.

In one embodiment the active gripper is pneumatically actuated. In another embodiment the active gripper comprises a servo gripper coupled to a linear motor. In one embodiment the active gripper provides feedback to the processor for determining positive engagement with the substrate. In another embodiment, the active gripper provides feedback to the processor for determining the center of the substrate.

In one embodiment, the invention features a prealigner including a prealigner chuck which is sized and configured to minimize contact with the surface of the substrate. In some embodiments, the prealigner chuck includes a plurality of projections or embattlements for supporting the substrate while it is rotated on the prealigner. In one example, the embattlements are sized and configured to allow full engagement of the grippers of the end effector with the substrate at any orientation of the a prealigner chuck. In one embodiment, the prealigner chuck includes a plurality of holes for optimizing the inertial properties and torque requirements of the chuck.

In another aspect, the invention features a method for handling substrates held in a carrier including moving a robotic arm across an edge of the substrates, determining coordinate information of the substrates in the carrier, storing the coordinate information, sequentially indexing the robotic arm to the substrates in the carrier according the stored coordinate information, measuring a distance to the substrate from the arm, and engaging the substrate with robotic arm. In one embodiment, the coordinate information includes at least one of mean vertical location, the thickness variation, the bow and warp, tilt and deviation of the substrate within the substrate carrier.

In another aspect, the invention features a method for handling substrates held in a cassette including providing a robotic arm including a mapping sensor and an end effector including a substrate sensor, moving the first sensor proximate to the cassette and recording the mean vertical substrate locations, generating a pick table including mean vertical substrate location data, sequentially indexing the robotic according to the mean vertical substrate locations of the pick table, engaging the cassette with the end effector, verifying the substrate position with the second sensor, and capturing and removing the substrate from the cassette with the robotic arm.

In one embodiment, the generating of the mean vertical substrate location data is accurate to within 135 microns. In another embodiment, the recording of the mean vertical substrate location is accurate to within 100 microns. In one embodiment, the method includes prealigning the substrate after removing the substrate from the cassette. In another embodiment, the robotic arm includes an end effector having a blade with a first end and a second end, the blade including an active area for sensing a distance between the end effector and the substrate. In one embodiment, the end effector includes a passive gripper attached to the first end of the blade and an active gripper attached to the second end of the blade.

In another aspect, the invention features a robotic end effector for holding a substrate and including a mapping sensor for detecting a mean vertical location of a substrate, a blade having a first end and a second end, an active area for sensing a distance between the end and the substrate located along the blade, and a passive gripper attached to the first end of the blade and an active gripper attached to the second end of the blade. In one embodiment, the active area of the end effector is formed from a metalization process. In another embodiment, the end effector includes a sensor for detecting the mean vertical location of a substrate. In still another embodiment, the active area of the end effector is at least three discrete sensors for providing planar information of the substrate. In various embodiments, the active area is adapted to provide at least one of the mean vertical location, the thickness variation, the bow and warp, tilt, and deviation of the substrate within the substrate carrier.

In one embodiment the active area comprises a measurement transducer. In one embodiment, the active area includes a laser transducer. In another embodiment, the blade is turned from a silicon wafer. In still another embodiment, the blade is formed from a ceramic substrate. In various embodiments, the blade has a thickness less than about 1000 microns and preferably, less than about 750 microns.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a front perspective view of a system for handling substrates.

FIG. 1B is a partially exploded perspective view of the system of FIG. 1A with them enclosure panels removed.

FIG. 2A is a rear perspective view of the system of FIG. 1A with the enclosure panels removed.

FIG. 2B is an enlarged rear perspective view of the system of FIG. 1A.

FIG. 3 is a perspective view of an articulating robotic arm.

FIG. 4A is a top perspective view of an end effector attached to a portion of the robotic arm.

FIG. 4B is a bottom perspective view of an end effector attached to a portion of the robotic arm.

FIG. 4C is bottom perspective view of an end effector depicting the mapping sensor for scanning the substrates containing with cassette.

FIG. 5A is a side perspective view of an end effector.

FIG. 5B is a partially exploded perspective view of the end effector of FIG. 5A.

FIG. 6A is a perspective view of an end effector engaging a substrate.

FIG. 6B is a perspective view of the end effector of FIG. 4A with the guard box removed.

FIG. 7 is a schematic side view of the end effector.

FIG. 8 is a detailed schematic side view of an end effector.

FIGS. 9A to 9C are schematic views of a cassette holder for the storage and transport of substrates.

FIG. 10 is a schematic side view of an end effector engaging the cassette holder of FIGS. 9A to 9C.

FIG. 11 is a detailed schematic view of a cassette holder containing substrates.

FIG. 12 is perspective view of a prealigner.

FIG. 13 is a side view of a chuck assembly for the prealigner.

FIG. 14 is a flow chart representing exemplary process steps of a sorter application.

FIG. 15 is a flow chart representing exemplary process steps of an operational sequence for calibration of the robotic arm sensors.

FIG. 16 is a flow chart representing exemplary process steps of an operational sequence for a mapping the positions of substrates within a cassette holder.

FIG. 17 is a flow chart representing exemplary process steps for engaging and gripping a substrate.

FIG. 18 is a flow chart representing exemplary process steps for an operational sequence for centering and finding a fiducial of the substrate.

Like reference symbols in the various drawings indicate like elements.

### DETAILED DESCRIPTION

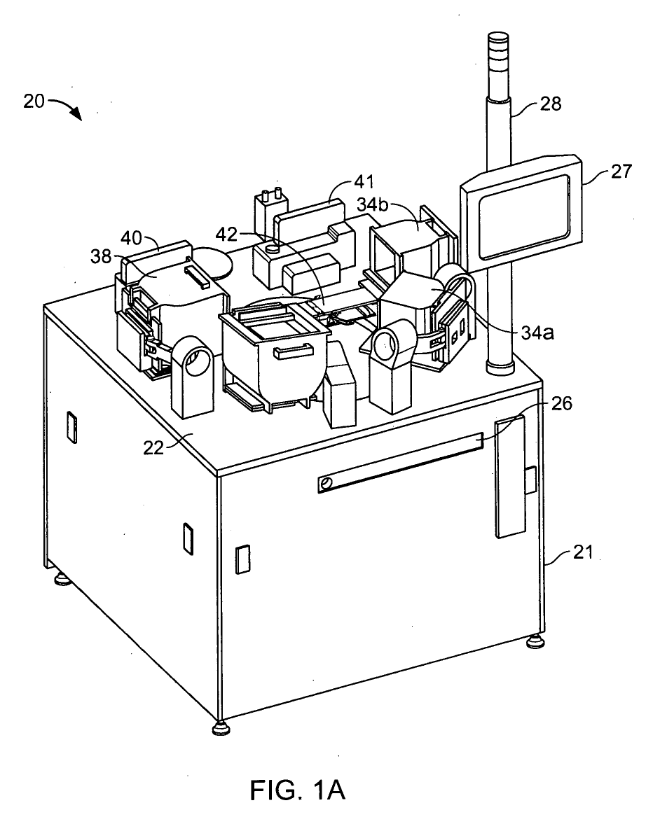

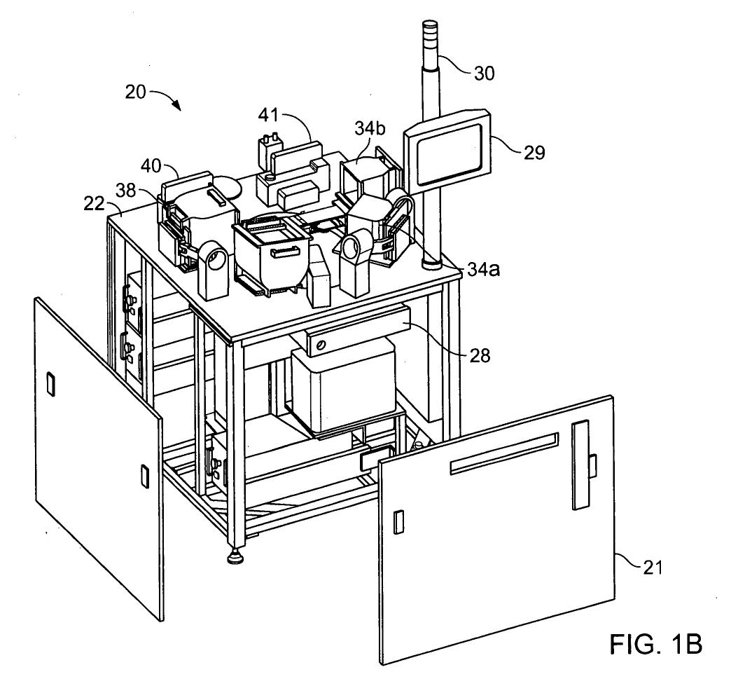

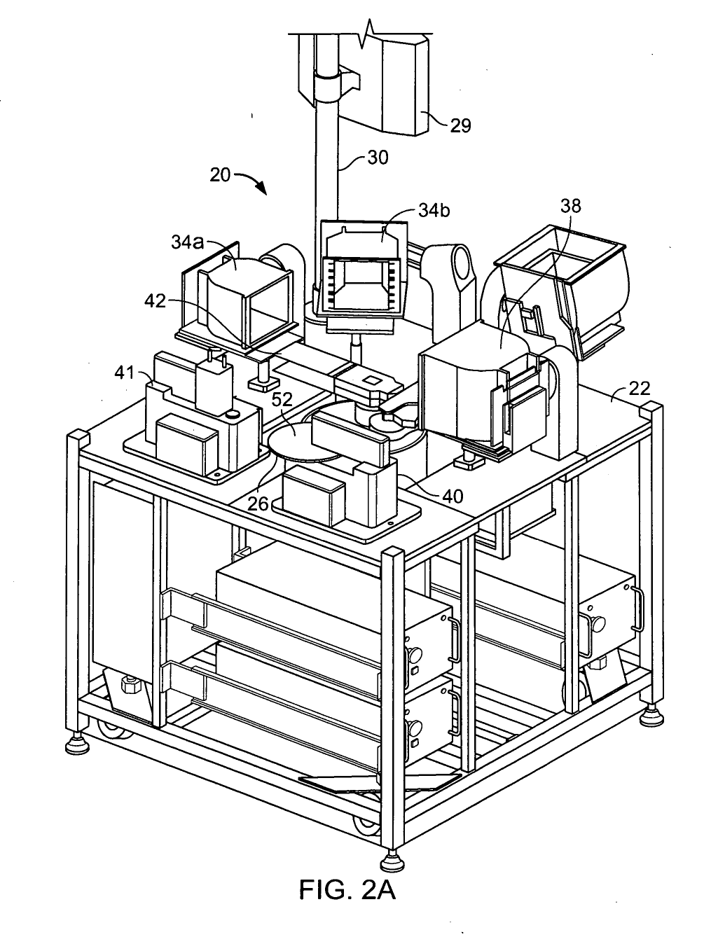

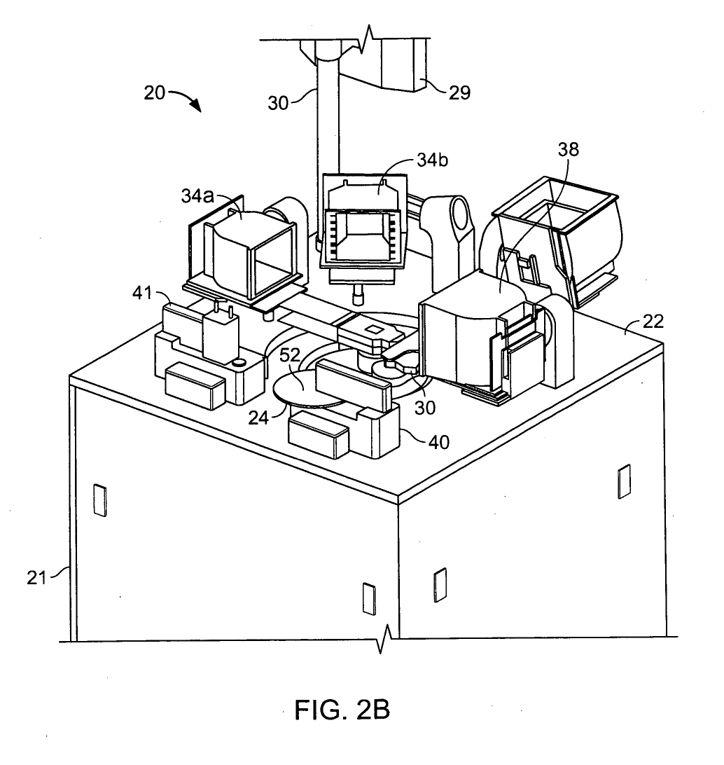

Referring collectively to FIGS. 1A, 1B, 2A and 2B, a representative processing system 20 for handling substrates includes an enclosure 21 and an operation area 22 for the processing of a substrate 24 (FIG. 2B) including, for example, a semiconductor wafer. The enclosure 21 can include a drawer 26 for a keyboard and a graphical user interface 27, such as a flat panel display secured to a mounting post 28, for user input to a system computer (not shown). The enclosure 21 can also house a number of ancillary components including, for example, a power supply, a computer, pneumatic pump and controller, and storage (not shown). In one example, the system 20 is configured for complete processing of the semiconductor wafers 24 for routing through multiple fabrication facilities. As semiconductor wafers 24 have grown increasingly larger and thinner, the loading and unloading of the wafers 24 has become concomitantly more exacting.

An important consideration in thin wafer design is that the substrate 24 is flexible and can be readily flattened and transported. The operation area 22 can include an articulating robotic arm 30 universal cassettes or input cassettes 34a, 34b, an output cassette 38, and a prealigner 40. In one example, the system 20 includes a substrate scanner 41. In one example, robotic arm 30 includes one or more end effectors 42 attached to an end of extender 44. In one example, robotic arm 30 is a Robot ROB 310 and the end effector 42 is a flipper-type end effector.

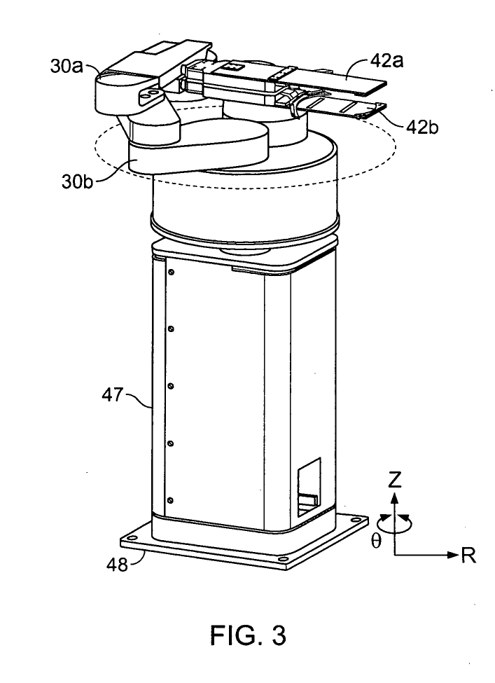

Referring to FIG. 3 and in one embodiment, the system 20 includes two robotic arms 30a, 30b each having 4-degrees of freedom. The robotic arms 30 can include one or more articulating arm linkages 46 and are attached to a mast 47 secured by a base 48. End effectors 42a, 42b are coupled to the robotic arms 30 such that the end effector 42 can be rotated one-hundred-eighty degrees. The robotic arms 30 can be controlled by a Motoman ERC robot controller, for example. The robotic arms 30 are configured to move the end effectors 42 in radial, rotational and vertical directions, denoted by arrows R, θ, and Z, respectively.

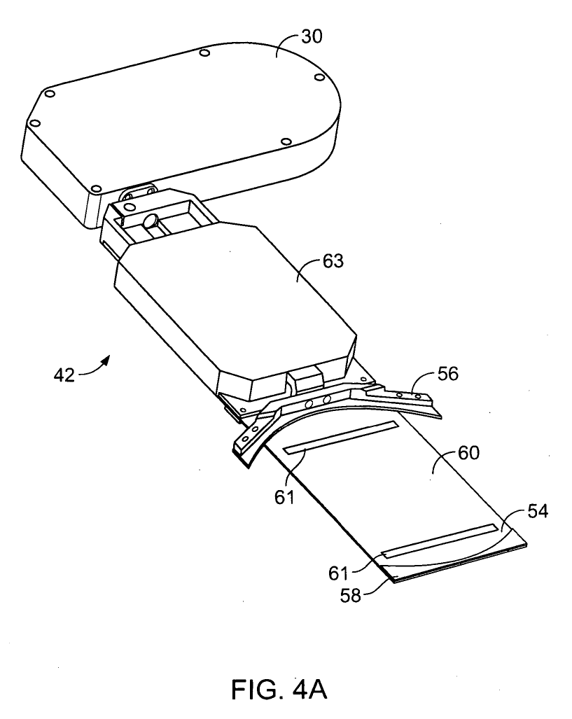

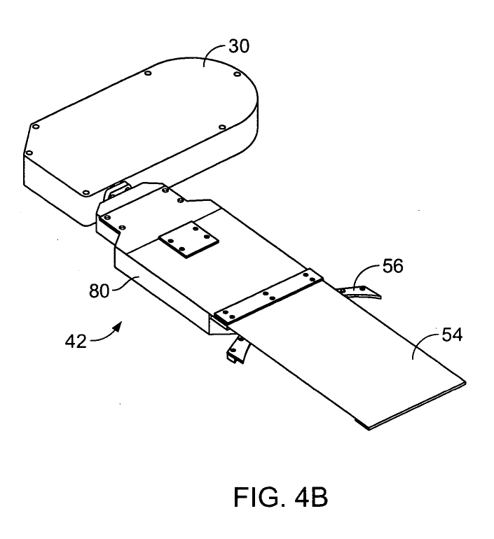

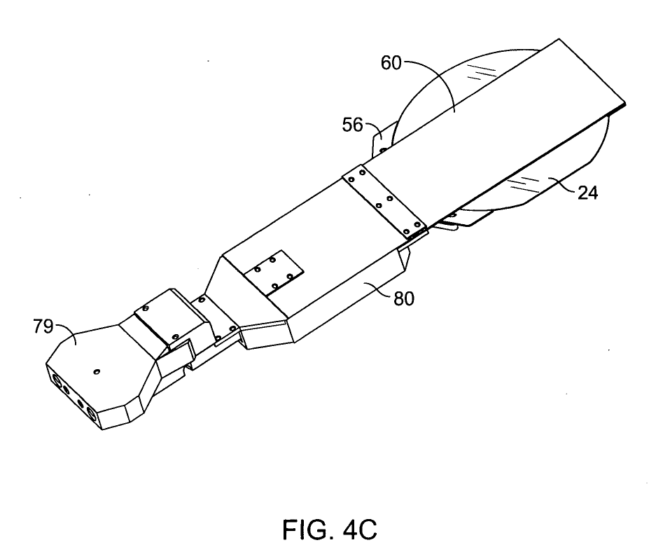

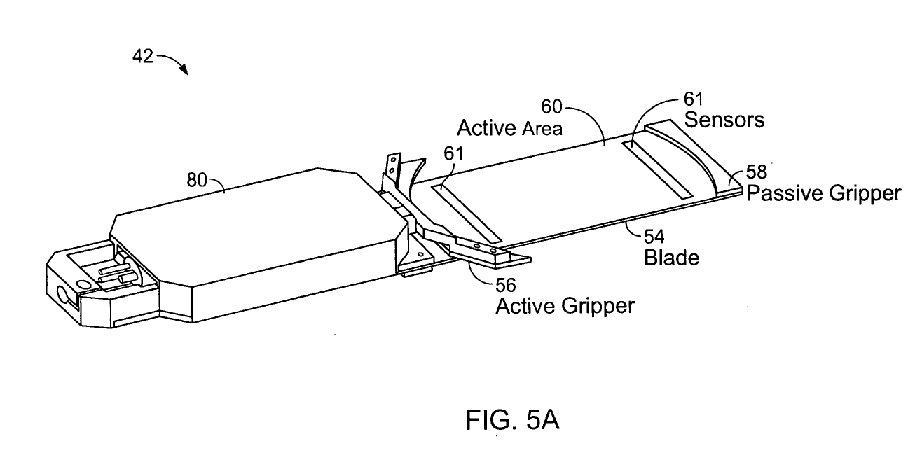

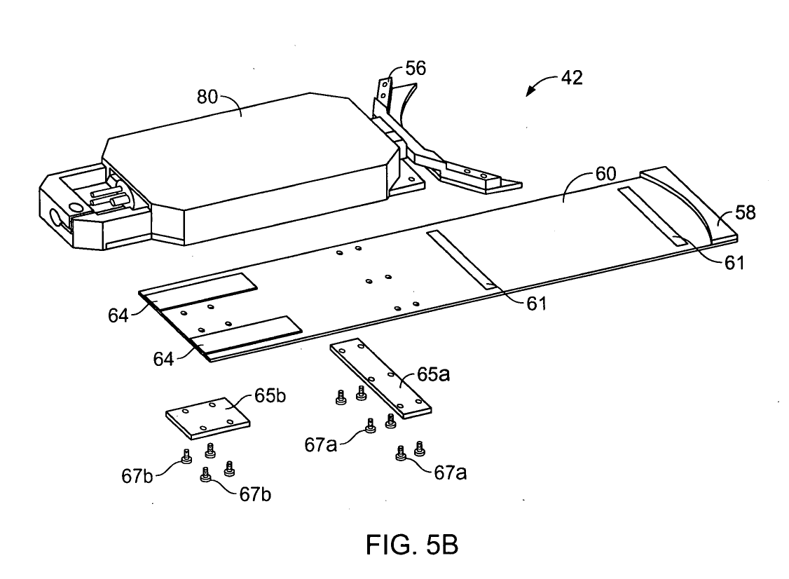

Referring collectively to FIGS. 4A, 4B, 4C, 5A, 5B, 6A, and 6B the end effector 42 of the robotic arm 30 for the processing of substrate materials includes a blade or paddle 54 with first and second end grippers 56, 58 located along proximal and distal ends of the blade 54, respectively. To minimize the thickness of the end effector 42, in one example, the blade 54 is formed from a ceramic substrate. In one example, the blade is about 700 microns thick, about 3 inches wide, and about 8 inches long. In other examples, the blade 54 is formed from silicon, and more specifically, a semiconductor wafer. In one example, the first end gripper 56 is active, i.e., capable of movement with respect to the blade and the second end gripper 58 is passive, i.e., affixed along a distal end of the blade 54. The blade 54 can be reinforced and attached to the guard box 80 with fastening strips 65a, 65b using fasteners 67a, 67b (FIG. 5B).

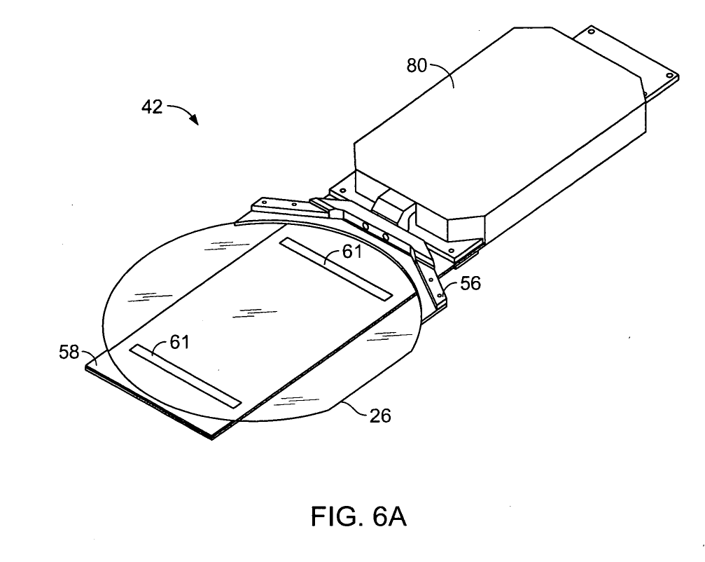

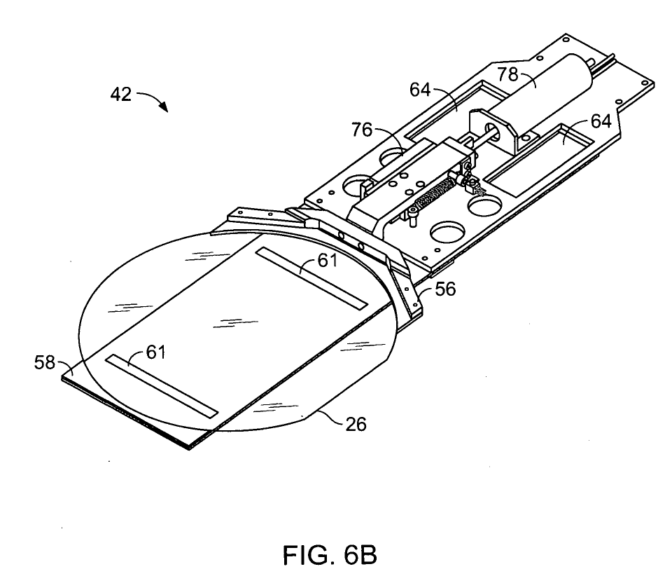

In one example, the second end gripper 58 is constructed from high molecular weight plastic, such as PEEK® (Victrex Plc Corporation, Lancashire United Kingdom) material and the first end gripper 56 is made from a conductive material to discharge or prevent charge build-up of the substrate 24. In one example, the second end gripper 58 is has an arcuate shape substantially conforming to the shape of the substrate 24 (shown in phantom in FIGS. 6A and 6B) and is further sized and configured to substantially cover the distal (leading) end of the blade 54. The second end gripper 58 can provide a shock absorption function to protect the blade 54 from damage during inadvertent impact of the leading end of the blade 54 with a hard surface. The first gripper 56 is can be actuated by a servo 76 coupled to a linear motor 78 (FIG. 6B), both housed within the guard box 80. Alternatively, the first gripper 56 can be actuated pneumatically.

The end effector 42 can include a plurality of sensors for sensing the location and mean position of the substrates 24. The end effector 42 can be equipped with a mapping sensor 79 (FIG. 4C) disposed on the robot arm 30 and an active area 60 including substrate sensors 61 disposed directly on the blade 54, in one example. The mapping sensor 79 can be a laser transducer, but other types of sensors are contemplated, including optical, inductive, and ultrasonic sensors, for example. An artifact (not shown) is located on the robotic arm 30 for a reference calibration point for both sensors 61, 79.

Once the blade 54 is cut to shape, a thick film or metalization process is performed on an outer surface of the blade 54 to form the active area 60 for detecting the presence and proximity of the substrate 24. The thick film process can include a paste and oven process, for example. The thick film process permits the addition of the active area 60 directly on the blade 54 with substantially no increase in thickness to a surface of the blade 54. In one example, the active area 60 is only about a few microns in thickness. The active area 60 can include a non-contact sensor transducer 61 such as a push-pull capacitive sensor, for example. The substrate sensor 61 can include guard rings (not shown) attached proximally thereto to increase durability. The substrate sensor 61 can be electrically connected to the system 20 via conductors located generally along areas 64 applied to the blade 54 using the thick film or metalization process used for forming the active area 60. A ground plane (not shown) can also be layered onto the blade 54 using a thick film process between the substrate sensor 61.

In one example, the dynamic range of the substrate sensor 61 is about 4.0 mm and has a working stand off of about 0.8 mm. In one example, the substrate sensor 61 provides a TTL digital output and a ±5.0 VDC analog output for calibration. In one example, the substrate sensor 61 detects the capacitance or the amount of charge induced by the substrate 24 positioned proximally to the substrate sensor 61. The system 20 is equipped with charge measuring circuitry (not shown) to determine the distance of the substrate 24 from the end effector 42.

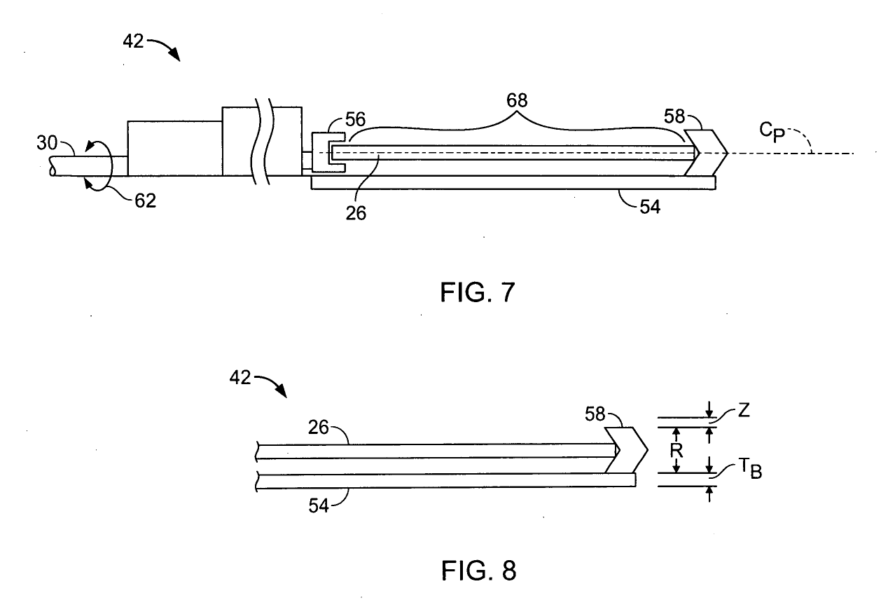

The end effector 42, shown schematically in FIG. 7 is rotatably attached to the robotic arm 30. The first and second grippers 56, 58 define a critical plane Cp for a reference in calculating end effector 42 coordinates. A capture zone 68 is defined between the first and second grippers 56, 58 along the blade 54. In operation, the robotic arm 30 rotates in the direction of arrow 62 one-hundred eighty degrees for displacement in one of two positions so that the end effector 42 engages the substrate 24 between the first end gripper 56 and the second end gripper 58 from either above or below the substrate 24. In one example, the grippers 56, 58 contact the substrate 24 about less than 3 mm from an outer edge. The end effector 42 can accommodate generally circular substrates with diameters from about 100 to 200 mm, in one example. For versatility, the blade 54 can be readily replaced with blades of multiple sizes generally corresponding to the dimension of the substrate 24.

In one example, the movement of the active first end gripper 56 is pneumatically actuated and can also be spring loaded to provide from about 1 to 16 ounces of force, depending on the type of the substrate 24. The grippers 56, 58 can include feedback sensors (not shown), such as monolithic transducer using silicon strain gauges to sense forces from engagement with the substrate 24. The grippers 56, 58 can also be equipped with integral optical sensors (not shown) to indicate to the system 20 when the substrate 24 is engaged. The first end gripper can be equipped with land-surface datum (LSD) integral sensors to indicate the position of the gripper 56 along the blade 54.

With reference to FIG. 8, exemplary dimensions are depicted for the end effector 42. In one example, the thickness T_{B} of the blade 54 is between about 0.4 mm to about 0.6 mm, and preferably about 0.5; the height of the grippers 56, 58 or a capture range R is between about 1.6 mm to about 2.0 mm, and preferably about 1.8 mm; and the clearance zone Z, the permissible distance between a top surface of the grippers 56, 58 and the next successive substrate, is between about 0.2 mm and 0.3 mm, and preferably about 0.25 mm. Other dimensions for the end effector 42 are contemplated for various applications and substrate sizes.

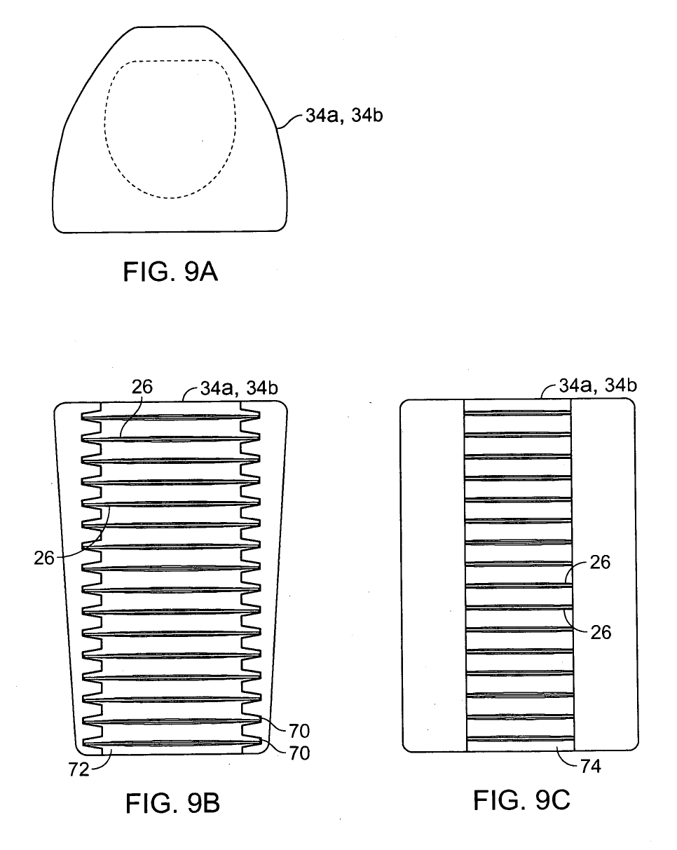

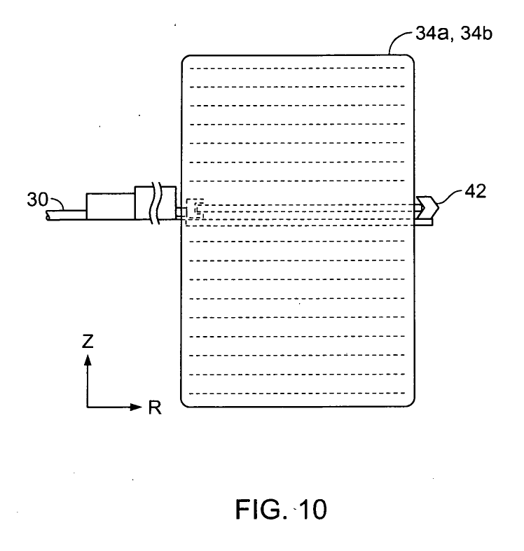

Referring now collectively to FIGS. 9A to 9C, 10 and 11, the input cassette 34a, 34b, in one example, includes a number of uniformly spaced slots 70 for supporting a number of substrates 24 in a generally horizontal configuration. The front of holder, as shown in FIG. 9B, includes a wide opening 72 for the loading and unloaded of the substrates 24. The slots 70 are spaced to permit the passage of the end effector 42 between adjacent substrates 24. The back of holder, as shown in FIG. 9C, includes a cutout 74 large enough to permit passage of the leading edge of the end effector 42, as shown in FIG. 10. Generally, the robotic arm 30 is advanced along a Z direction (as denoted by the arrow in FIG. 10) until the end effector 42 corresponds to an interstitial space between the adjacent substrates 24 arranged in the input cassette 34a, 34b. The robotic arm 30 is then advanced in an R direction (as denoted by the arrow in FIG. 10) until the end effector 42 passes under or over the particular substrate 24 that is to be removed from the input cassette 34a, 34b. As the second gripper 58 proceeds past the cutout 74 to clear the edge of the substrate 24, the robotic arm 30 advances slightly upward in the Z direction (or downward, if the substrate 24 is captured from above) to place the substrate 24 within the capture zone 68 (FIG. 7) between the first and second grippers 56, 58. The first gripper 56 next moves in the R direction to capture the substrate between the grippers 56, 58. The robotic arm 30 retracts from the input cassette 34a, 34b carrying the substrate 24.

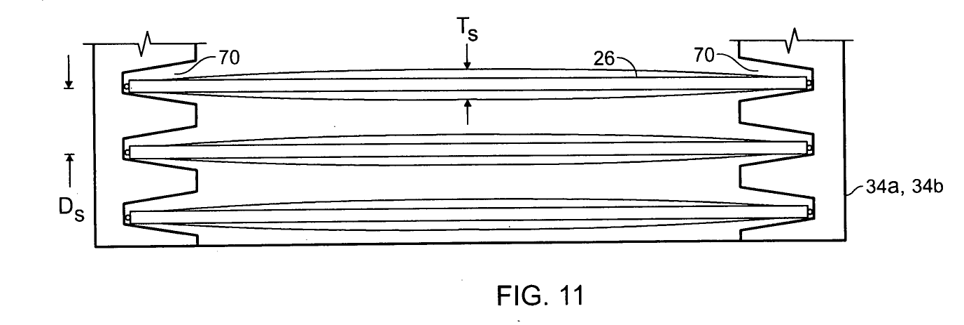

Referring to FIG. 11, the substrates 24 are positioned within the slots 70 of the input cassette 34a, 34b. Adjacent substrates are separated by a distance Dₛ. The physical properties of the substrate 24 and the input cassette 34a, 34b are considered to determine the possible vertical zone occupied by the substrate 24 disposed in the input cassette 34a, 34b. As the thickness and the spacing of the substrate 24 within the input cassette 34a, 34b decreases, requirements for handling the substrate 24 while concomitantly maintaining acceptable throughput increases. Multiple substrate 24 parameters can be considered when evaluating the requirements of the end effector 42 including the nominal thickness, thickness tolerance, thickness variation and bow and/or warp of the substrate 24 along the length. The pitch tolerance of the slots 70 of the input cassette 34a, 34b and the angle of the slot 70 with respect to vertical alignment of the substrate 24 can also be considered for determining the requirements of the system 20.

With continued reference to FIG. 11, the total possible vertical space Tₛ that can be occupied by the substrate 24 is determined by summing the center point thickness of the substrate 24, the substrate thickness tolerance, the thickness variation the bow or warp amount, the pitch tolerance, the slot 70 angle with respect to the horizontal alignment (i.e., determinable movement of the substrate 24 within the slots 70 of the input cassette 34a. 34b due to the angle of the slots). In a representative example, the Tₛ is about 1900 microns.

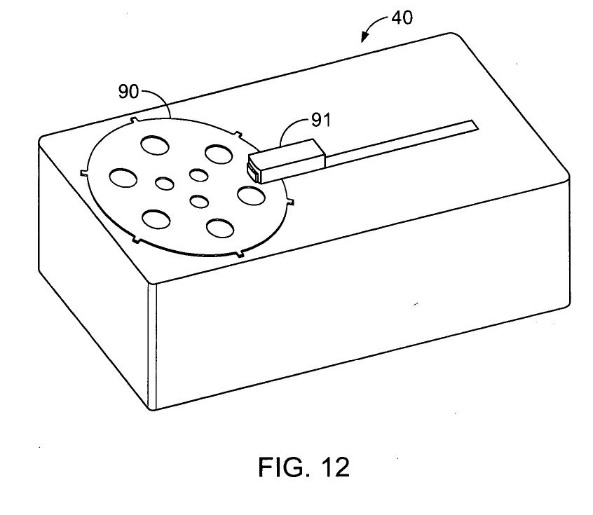

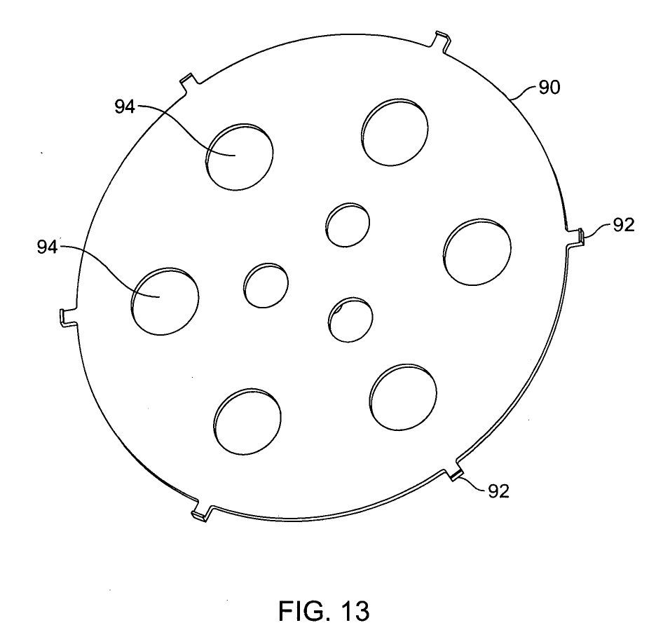

Referring to FIGS. 12 and 13 and in one example, the prealigner 40 includes a prealigner chuck 90 (FIG. 13). The prealigner chuck 90 is sized and configured to minimize contact with the surface of the substrate 24. For a substantially circular substrate 24, an exclusion zone extends about 3 mm from the outside circumferential periphery of the substrate 24 wherein handling contact is permissible. The prealigner chuck includes a plurality of projections or embattlements 92 for supporting the substrate 24 while it is rotated on the prealigner 40. The embattlements 92 can be sized and configured for asperity contact with the substrate 24. In one example, six embattlements 92 are uniformly located around the outside circumferential periphery of the substrate 24. In one example, the embattlements 92 are sized and configured to allow full engagement of the grippers 56, 58 of the end effector 42 with the substrate 24 at any orientation of the a prealigner chuck 90. The prealigner chuck 92 can include a plurality of holes 94 for optimizing the inertial properties and torque requirements of the chuck 92.

In one example, the prealigner 40 is an Integrated Dynamics Engineer SPA 310 prealigner (sorter version) and includes a prealigner controller (not shown). The prealigner 40 can also include inspection capability such as a Cognex Insight 1700 vision system or an inspection station for detecting defects on the surface of the substrate 24. The vision system can automatically adjust for differing diameters of the substrate 24.

In operation, the robotic arm 30 grasps a substrate 24 from either of the two input cassettes 34a, 34b and places the substrate 24 onto the prealigner 40, if an identification reading of the substrate 24 is required. In some examples, the wafers 24 are placed into either the substrate shipper 38 or the two input cassettes 34a, 34b in predetermined orientations. In some examples, the substrate 24 is asymmetric and includes a “flat” or fiducial to provide a reference point and the prealigner 40 detects this asymmetry while rotating the substrate 24. The prealigner 40 can then rotate the substrate 24 to a predetermined orientation as a function of the asymmetry. The robotic arm 30 picks up the substrate 24 by applying vacuum pressure at the end effector 42, flips the substrate 24 upside down, and moves the substrate 24 over the substrate shipper 38. The robotic arm 30 then releases the substrate 24 to allow the substrate 24 to float gently down onto the stack of wafers 24 in the substrate shipper 38. A sensor (not shown) can be provided to check for a correct presence of an interleaf sheet 27 before releasing the substrate 24 into the substrate shipper 38.

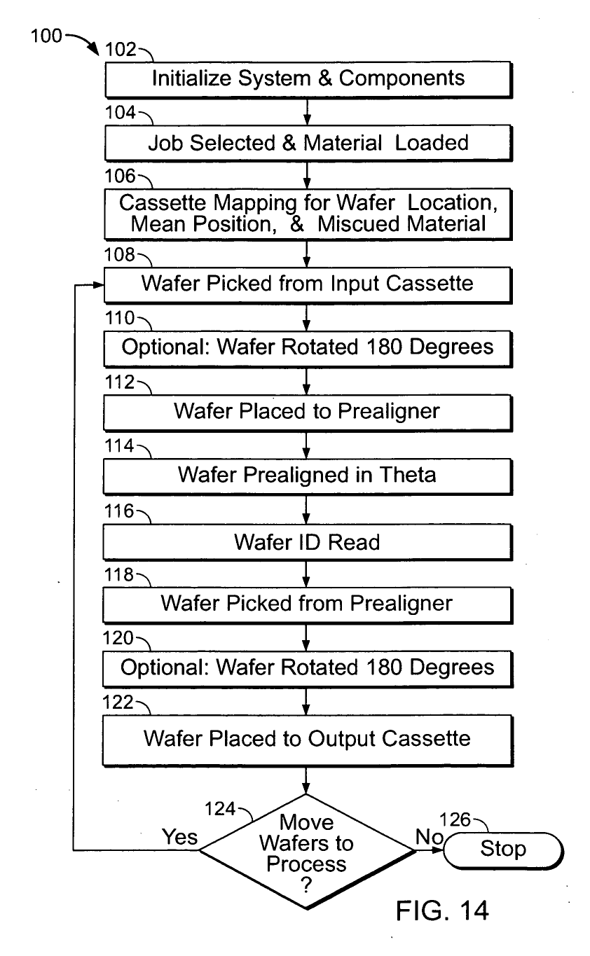

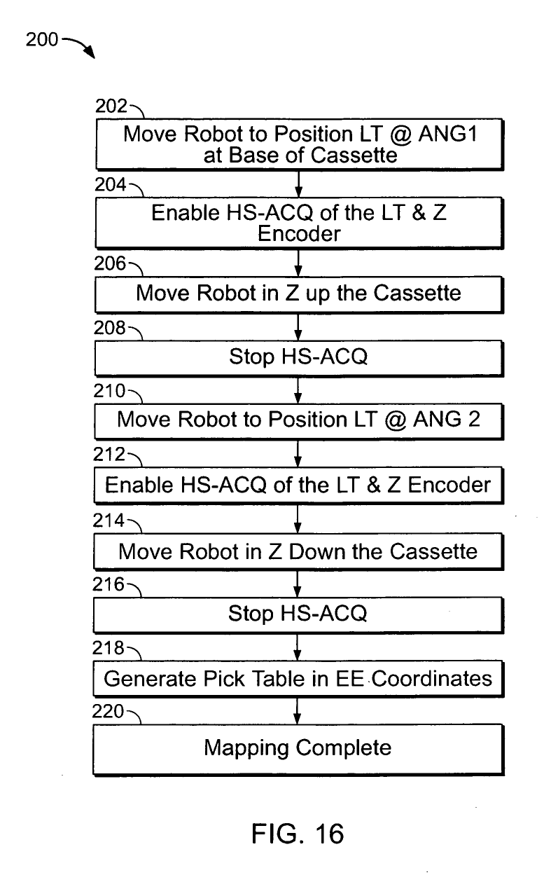

Referring to FIG. 14, a process 100 for aligning and reading substrates 24 initializes (102) the system 20 and the system components. Process 100 selects (104) a particular job to execute and the corresponding materials which are loaded. Process 100 (106) maps the input cassette 34a, 34a with the mapping sensor 79 (described in more detail in connection with FIG. 16) for determining the location and position of the substrate 24 and for detected miscued substrates within the input cassettes 34a, 34b. Process 100 picks (108) a substrate 24 from an input cassette 34a, 34b and rotates (110) the substrate 24 one-hundred-eighty degrees, if required. Process 100 places (112) the substrates on the prealigner 40 for, in one example, aligning (114) the substrate with a particular orientation in the θ direction for placement in the output cassette 38. Process 100 reads (116) the substrate identification information while positioned in the prealigner 40. Process 100 picks (118) the substrate 24 from the prealigner 40 and rotates (120) the substrate 24 one hundred eighty degrees, if required. Process 100 places (122) the substrate 24 in output cassette 38. Process 100 determines (124) if additional substrates 24 require processing, and if necessary returns to picking (108) the remaining substrate 24 from the input cassettes 34a, 34b. When all substrates 24 are processed, process 100 terminates (126).

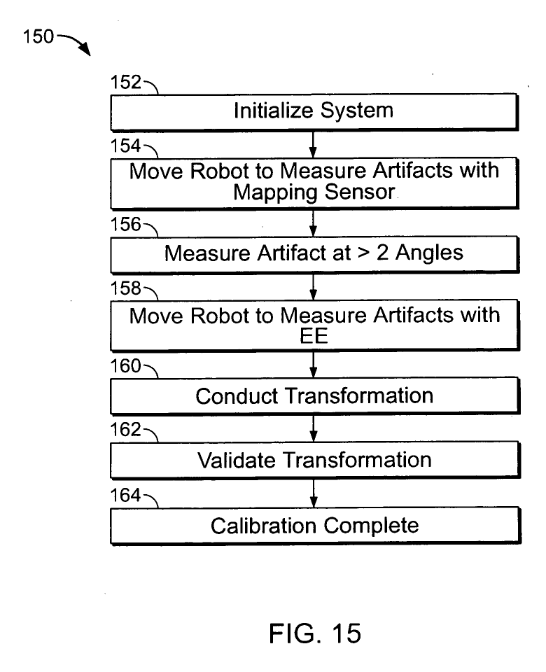

Referring to FIG. 15, a process 150 for calibrating the substrate sensor 61 and the mapping senor 79 initializes (152). Process 150 moves (154) the robotic arm 30 to measure the artifact with the mapping sensor 79. Process 150 measures (156) the artifact with the robotic arm 30 at two or more different positions with respect to the artifact. Process 150 moves (158) the robotic arm 30 to measure the artifact with the substrate sensors 61. Process 150 performs (160) a linear transformation and validates (162) the transformation by, for example, picking a substrate 24 from the input cassette 34a, 34b. Process 150 then completes (164) the calibration.

It should be understood that in some examples, the substrate sensor 61 and/or the mapping sensor 79 of the end effector 42 obviates the need for a separate process 100 for aligning the substrates 26 as the orientation of the substrates 24 is determined in the process 200 described as follows.

Referring to FIG. 16, a process 200 for mapping the location of the substrates 24 positioned within the input cassettes 34a, 34b moves (202) the robotic arm 30 to face the mapping sensor 79 toward the input cassettes 34a, 34b at a first angle with respect to the critical plane Cₚ (FIG. 7). Process 200 enables (204) high resolution acquisition with the mapping sensor 79 for recording the output of the reflected mapping sensor 79, at for example, 1 millisecond intervals. Process 200 moves (206) the robotic arm 30 in the Z direction up the open face 72 of the input cassettes 34a, 34b. The mapping sensor 79 remains “on” until it clears a top edge of the substrate 24.

When the top of the input cassette 34a, 34b is reached, process 200 stops (208) the high resolution acquisition. In so doing, the mapping sensor 79 provides a thickness measurement of all substrates 24 in the input cassette 34a, 34b. In some examples, due to the effects of latency, hysteresis, the speed of the robotic arm 30, and the quality of the edge of the substrate 24, the measured thickness of the substrate 24 may not be the actual thickness of the substrate 24. Accordingly, process 200 moves (210) robotic arm 30 to face the mapping sensor 79 toward the input cassette 34a, 34b at a second angle and enables (210) high resolution acquisition with the laser sensor at this second angle. Process 200 moves (214) the robotic arm 30 in the Z direction down the open face 72 of the input cassette 34a, 34b. The mapping sensor 79 remains on until it clears a bottom edge of the substrates 24. Process 200 stops (216) the high resolution acquisition when the robot 30 reaches the bottom of the input cassette 34a, 34b.

With information acquired in the enabling 204 at the first angle and the enabling 212 at the second angle, a more accurate measurement of the position and orientation of the substrate 24 can be obtained. Process 200 generates (218) a pick table of the locations measured by the mapping sensor 79, translated into end effector 42 coordinates (with respect to the critical plane Cₚ). The pick table can inform the robotic arm 30 if a substrate is double slotted (two substrates contained within a single cassette slot 70 or cross-slotted.) Generating the pick table requires a linear transformation between the mean position of each substrate 24 along the Z-axis and generating coordinates with respect to the critical plane Cₚ. By considering the mean position of a first substrate along the Z-axis and a next substrate, a safe Z position for the end effector 42 to enter the input cassette 34a, 34b is determined by the linear transformation. After the pick table is generated in 218, process 200 is concludes (220).

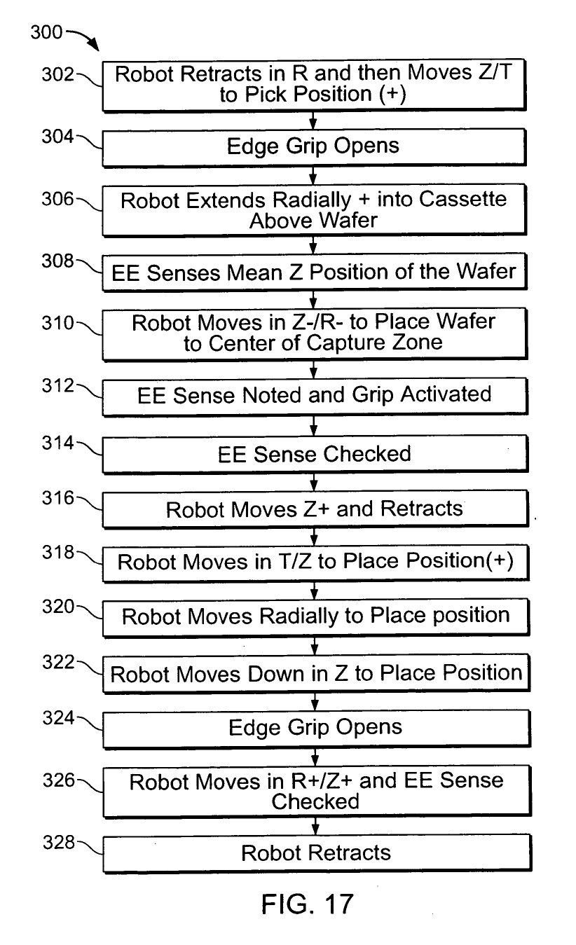

Referring to FIG. 17, a process 300 for engaging and retracting a substrate 24 retracts (302) the robot 30 in the R-direction and moves the robot 30 in the Z and the θ directions to the first substrate pick position. Process 300 opens (304) the edge grippers 56, 58 of the end effector 42. Process 300 extends (306) the robot 30 in the R-direction into the input cassette 34a, 34a (see FIG. 10, for example). Process 300 senses (308) the mean vertical position of the substrate 24 and moves (310) the robot 30 in the Z and R directions to position the substrate 24 in the center of the capture zone 68 of the end effector 42. Process 300 activates (312) the grippers 56, 58 and the sensor 61 signal is checked (314) and the robot 30 moves (316) slightly upward in the Z-direction and retracts from the input cassette 34a, 34b. Process 300 moves the robot 30 (318) positively in the θ and Z directions to place position, including for example, the output cassette 38, for the substrate 24. Process 300 moves (320) the robot 30 in the R-direction to the place position and moves the robot 30 (322) downward in the Z-direction to the place position for the substrate 24. Process opens (324) the edge grippers 56, 58 of the end effector 42 and moves the robot 30 (326) in the R and Z directions and the sensor 61 signal is checked (326) and the robot 30 retracts (328) from the place position.

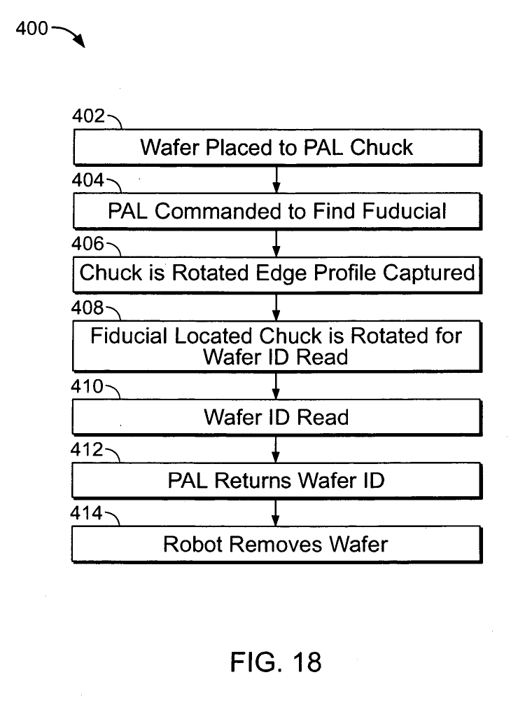

Referring to FIG. 18, a process 400 for aligning a substrate 24 places (402) a substrate 24 upon the prealigner chuck 90 and commands (404) the prealigner (404) to locate the asymmetric flat or the fiducial of the substrate 24. Process 400 rotates (406) the prealigner chuck 90 until the edge profile of the substrate 24 is ascertained. Process 400 then rotates (408) the substrate 24 for reading the substrate ID having a position which is known with respect to the fiducial. Process 400 reads (410) the substrate ID and returns (412) the substrate ID to the system 20. Process removes (414) the substrate 24 from the prealigner chuck 90 and concludes.

A number of embodiments of the invention have been described. Nevertheless, it will be understood that various modifications may be made without departing from the spirit and scope of the invention. Accordingly, other embodiments are within the scope of the following claims.

What is claimed is:

1. A system for handling substrates held in a carrier, the system comprising:
a robot including an articulated robotic arm;
a processor for controlling the robotic arm;
an end effector attached to a moveable end of the robotic arm, the end effector comprising a blade having a first end and a second end, the blade having an active area for sensing a distance between the end and the substrate; and
a passive gripper attached to the first end of the blade and an active gripper attached to the second end of the blade.

2. The system of claim 1 wherein the end effector further comprises a mapping sensor for detecting the mean vertical location of a substrate disposed within the carrier.

3. The system of claim 1 wherein the blade comprises a silicon wafer.

4. The system of claim 1 wherein the blade comprises a ceramic.

5. The system of claim 1 wherein the blade has a thickness less than 1000 microns.

6. The system of claim 1 wherein the blade has a thickness less than 750 microns.

7. The system of claim 1 wherein the active area is formed on the blade from a metalization process.

8. The system of claim 1 wherein the active area is adapted to provide at least one of the mean vertical location, the thickness variation, the bow and warp, tilt, and deviation of the substrate within the substrate carrier.

9. The system of claim 1 wherein the active area comprises a measurement transducer.

10. The system of claim 1 wherein the active area comprises a capacitance probe.

11. The system of claim 1 wherein the active area comprises at least one of optical sensor, pneumatic sensor, inductive sensor, and ultrasonic sensor.

12. The system of claim 1 wherein the active area comprises at least three discrete sensors for providing planar information of the substrate.

13. The system of claim 1 wherein the active gripper is pneumatically actuated.

14. The system of claim 1 wherein the active gripper comprises a servo gripper coupled to a linear motor.

15. The system of claim 13 wherein the active gripper provides feedback to the processor for determining positive engagement with the substrate.

16. The system of claim 13 wherein the active gripper provides feedback to the processor for determining the center of the substrate.

17. The system of claim 1 further comprising a substrate prealigner, the prealigner comprising a prealigner chuck.

18. The system of claim 17 wherein the prealigner chuck comprises a plurality of embattlements for engaging the substrate only along the exclusion zone.

19. The system of claim 17 wherein the prealigner chuck is sized and configured to reduce rotational inertia.

20. The system of claim 19 wherein the prealigner chuck comprises a plurality of holes.

21. A method for handling substrates held in a carrier, the method comprising:
moving a robotic arm across an edge of the substrates;
determining coordinate information of the substrates in the carrier;
storing the coordinate information;
sequentially indexing the robotic arm to the substrates in the carrier according the stored coordinate information;
measuring a distance to the substrate from the arm; and
engaging the substrate with robotic arm.

22. The method of claim 21 wherein the coordinate information includes at least one of mean vertical location, the thickness variation, the bow and warp, tilt and deviation of the substrate within the substrate carrier.

23. A method for handling substrates held in a cassette, the method comprising:
providing a robotic arm including a mapping sensor and an end effector including a substrate sensor;
moving the first sensor proximate to the cassette and recording the mean vertical substrate locations;
generating a pick table including mean vertical substrate location data;
sequentially indexing the robotic according to the mean vertical substrate locations of the pick table;
engaging the cassette with the end effector;
verifying the substrate position with the second sensor; and
capturing and removing the substrate from the cassette with the robotic arm.

24. The method of claim 23 wherein the generating of the mean vertical substrate location data is accurate to within 135 microns.

25. The method of claim 23 wherein the recording of the mean vertical substrate location is accurate to within 100 microns.

26. The method of claim 23 further comprising prealigning the substrate after removing the substrate from the cassette.

27. The method of claim 23 wherein the robotic arm includes an end effector comprising a blade having a first end and a second end, the blade having an active area for sensing a distance between the end effector and the substrate.

28. The method of claim 23 wherein end effector includes a passive gripper attached to the first end of the blade and an active gripper attached to the second end of the blade.

29. A robotic end effector for holding a substrate, the end effector comprising:
a mapping sensor for detecting a mean vertical location of a substrate;
a blade having a first end and a second end;
an active area for sensing a distance between the end and the substrate located along the blade; and
a passive gripper attached to the first end of the blade and an active gripper attached to the second end of the blade.

30. The robotic end effector of claim 29 wherein the active area is formed from a metalization process.

31. The robotic end effector of claim 29 wherein the end effector includes a sensor for detecting the mean vertical location of a substrate.

32. The robotic end effector of claim 29 wherein the active area comprises at least three discrete sensors for providing planar information of the substrate.

33. The robotic end effector of claim 29 wherein the active area is adapted to provide at least one of the mean vertical location, the thickness variation, the bow and warp, tilt, and deviation of the substrate within the substrate carrier.

34. The robotic end effector of claim 29 wherein the active area comprises a measurement transducer.

35. The robotic end effector of claim 29 wherein the active area comprises a capacitance probe.

36. The robotic end effector of claim 29 wherein the active area comprises at least one of optical sensor, pneumatic sensor, inductive sensor, and ultrasonic sensor.

37. The robotic end effector of claim 29 further comprises a mapping sensor for detecting the mean vertical location of a substrate.

38. The robotic end effector of claim 35 wherein the mapping sensor comprises a laser transducer.

39. The robotic end effector of claim 29 wherein the blade comprises a silicon wafer.

40. The robotic end effector of claim 29 wherein the blade comprises a ceramic substrate.

41. The robotic end effector of claim 29 wherein the blade has a thickness less than 1000 microns.

42. The robotic end effector of claim 29 wherein the blade has a thickness less than 750 microns.
